(19) United States
(12) Patent Application Publication
(10) Pub. No.: US 2018/0034181 A1
(43) Pub. Date: Feb. 1, 2018

(54) ELECTRIC MOTOR VEHICLE SECONDARY ASSEMBLY

(71) Applicant: PIERBURG PUMP TECHNOLOGY GMBH, NEUSS (DE)

(72) Inventors: RONALD RATHKE, DOEBELN (DE); ALEXANDER FINDEISEN, DOEBELN (DE)

(73) Assignee: PIERBURG PUMP TECHNOLOGY GMBH, NEUSS (DE)

(21) Appl. No.: 15/543,237

(22) PCT Filed: Jan. 15, 2015
(86) PCT No.: PCT/EP2015/050663

§ 371 Date: Jul. 13, 2017

(51) Int. Cl. H01R 13/405; H02K 5/08; H02K 5/22; H02K 11/33

(52) U.S. Cl. CPC H01R 13/405; H02K 11/33; H02K 5/08; H02K 5/225; H02K 5/10

(57) ABSTRACT

An electric motor vehicle secondary assembly includes a housing body with a housing opening, a drive motor, a device driven by the drive motor, a connector arrangement with at least two exposed connector pins, a cast body with a connector core integrally molded thereon, and a motor control circuit board which is partially potted in the cast body. The connector core forms a connector base. The connector pins are each formed by a respective single rigid pin element which is directly electrically connected to the motor control circuit board. The connector core of the cast body encloses each pin element between the motor control circuit board and the connector base. The connector core is plugged into the housing opening of the housing body so that the connector base completely closes the housing opening and the pin elements project outward from the connector base through the housing opening.

### CROSS REFERENCE TO PRIOR APPLICATIONS

This application is a U.S. National Phase application under 35 U.S.C. § 371 of International Application No. PCT/EP2015/050663, filed on Jan. 15, 2015. The International Application was published in German on Jul. 21, 2016 as WO 2016/112980 A1 under PCT Article 21(2).

### FIELD

The present invention relates to an electric secondary assembly for motor vehicles, for example, to an electric water recirculation pump.

### BACKGROUND

The term motor vehicle secondary assembly as used herein is intended to include all secondary assemblies that do not immediately serve to drive the motor vehicle, but are designed, for example, as a pump, an actuator, or as a mechanical switch. The respective working device can, for example, be driven by an electronically commutated drive motor since electronic commutation is free of wear and, in particular with pumps, allows a hermetic separation of the pump fluid from the commutation electronics if the drive motor is designed as a so-called canned motor.

The commutation electronics is generally substantially located on a motor control circuit board which may be equipped on one side or on two sides. Connecting lines lead from the motor control circuit board to a peripheral connector arrangement arranged on a housing body of the assembly housing. After assembly of the motor vehicle secondary assembly into the motor vehicle, a corresponding mating connector can be plugged into the connector arrangement so as to electrically connect the motor vehicle secondary assembly to a vehicle control.

The electrical motor vehicle secondary assembly is most often mounted in the axial direction, wherein, after assembly of the motor control circuit board in a transversal plane that is oriented approximately perpendicular to the rotational axis of the drive motor, the interior is finally closed with a housing body or cover. The housing body or cover comprises the connector arrangement that must be electrically connected to the motor control circuit board or is connected to the motor control circuit board only during assembly. A permanently good electric connection of the two exposed connector pins of the connector arrangement to the motor control circuit board is of utmost importance for a reliable operation of the motor vehicle secondary assembly.

### SUMMARY

An aspect of the present invention is to provide an electric motor vehicle secondary assembly having electronic commutation which has a high electric reliability.

In an embodiment, the present invention provides an electric motor vehicle secondary assembly which includes a housing body comprising a housing opening, a drive motor configured to be electronically commutated, a working device configured to be driven by the drive motor, a peripheral connector arrangement comprising at least two exposed connector pins, a cast body comprising a connector core which is integrally molded thereon in one piece, and a motor control circuit board which is at least partly potted in the cast body. The connector core is configured to form a connector base. The at least two exposed connector pins are each formed by a respective single rigid pin element which is directly electrically connected to the motor control circuit board. The connector core of the cast body is configured to enclose each respective single rigid pin element between the motor control circuit board and the connector base. The connector core is plugged into the housing opening of the housing body so that the connector base completely closes the housing opening and the respective single pin elements project outward from the connector base through the housing opening.

### BRIEF DESCRIPTION OF THE DRAWINGS

The present invention is described in greater detail below on the basis of embodiments and of the drawings in which:

FIG. 1 shows a longitudinal section of a motor vehicle secondary assembly according to the present invention including a motor control circuit board potted in a cast body;

FIG. 2 shows a perspective view of the cast body including a part of the connector arrangement of the motor vehicle secondary assembly of FIG. 1; and

FIG. 3 shows a partial view of a longitudinal section of the connector arrangement of the motor vehicle secondary assembly of FIG. 1.

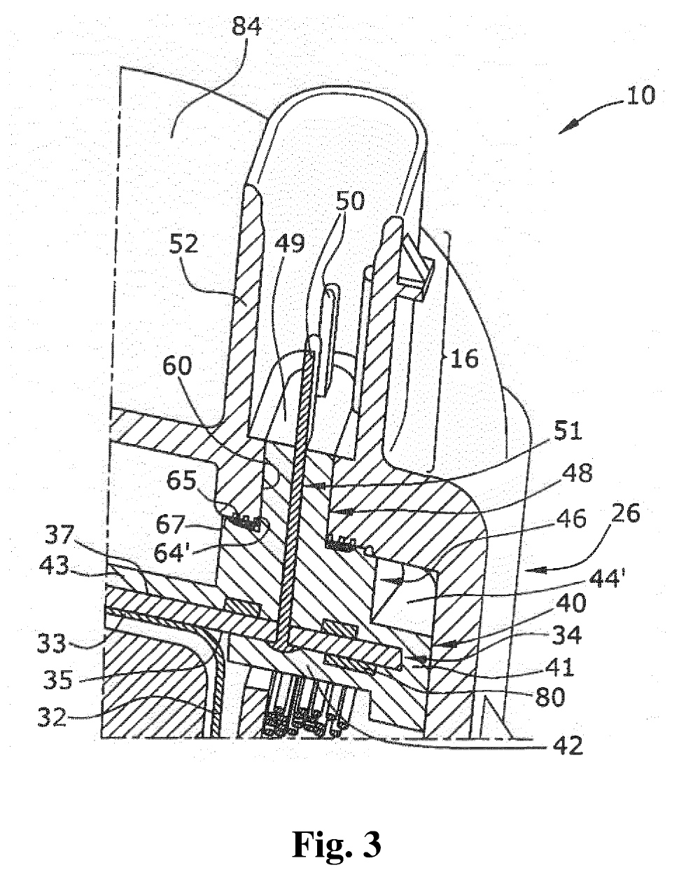

### DETAILED DESCRIPTION

The electric motor vehicle secondary assembly of the present invention comprises an electronically commutated drive motor driving the working device, for example, an impeller. The motor control is substantially located on a motor control circuit board which can, for example, be arranged in a transversal plane of the drive motor, i.e., a plane oriented transversely to the rotational axis of the drive motor. The motor control circuit board is at least partly encapsulated in a plastic cast body so as to in particular protect the thus potted electronics against humidity, the electronics being, for example, commutation electronics.

A plurality of rigid metal pin elements are electrically connected, for example, soldered, to the motor control circuit board, which, at their free ends, also form the connector pins of the peripheral connector arrangement. No further contact plane thus exists between the electric connection of the pin elements to the motor control circuit board and the connector pins. The electric reliability of the secondary assembly is thereby fundamentally increased.

The cast body has a connector core integrally formed thereon which encloses the pin elements so that the connector pins are not potted, while the pin elements are completely potted in the cast body between the connector pins and the motor control circuit board. At its distal end, the connector core forms a connector base from which the connector pins protrude upwards. The connector arrangement may have a connector collar that surrounds the connector pins. The connector collar may be formed by the cast body or by the housing body.

The housing body closes the assembly housing and has a housing opening into which the connector core is inserted, or through which the connector core is inserted, so that the connector base of the connector core fully encloses the housing opening.

The connector pins of the connector arrangement are thus formed by a plurality of rigid metal pin elements which are directly electrically connected, for example, soldered, to the motor control circuit board. The motor control circuit board including the connector pins is further reliably protected against humidity by a monolithic cast body and is mechanically formed into a single rigid structure so that, for example, vibration-related or assembly-related relative movements between the connector pins or the pin elements and the motor control circuit board are virtually excluded. All effects described together result in a high electric reliability of the motor vehicle secondary assembly.

In an embodiment of the present invention, the cast body can, for example, have at least two axial support noses by which the cast body is axially supported at the housing body. The cast body can, for example, have exactly three support noses by which the cast body is axially supported at the housing body. Due to the support noses, the cast body including the connector arrangement is positioned at a defined distance and in a defined spatial position with respect to the housing body. The support noses may of course alternatively be provided at the housing body according to the present invention.

In an embodiment of the present invention, the housing body can, for example, have at least two axial support sockets in which the corresponding support noses are supported axially. The term “support socket” is basically to be understood as any form of recess into which the corresponding support nose can protrude. In this manner, the support sockets in particular define the rotational position of the cast body including the connector arrangement and the motor control circuit board relative to the assembly housing or the respective housing body. An erroneous assembly is thereby reliably prevented during the mounting of the secondary assembly. The support noses and the corresponding support sockets can, for example, form a form fit which defines, for example, the rotational position, the radial position, and the axial position of the cast body relative to the respective housing body. The support noses may also basically be provided on the side of the housing body, and the support sockets may be provided on the side of the cast body.

In an embodiment of the present invention, the connector core can, for example, be seated on a connector socket that has a larger lateral outer circumference than the connector core. A circumferential shoulder is formed between the connector core and the connector socket, the shoulder lying, for example, in a transverse plane, wherein an elastic ring seal is arranged between the annular surface of the shoulder and a corresponding housing-side sealing surface. A reliable fluidic sealing of the housing interior is thereby achieved in this region.

The motor control circuit board, which can, for example, be arranged in a transverse plane, has a proximal side and a distal side. The proximal side is the side of the circuit board that faces the motor rotor and the motor stator in the axial direction. One or both sides can, for example, be at least partly potted or covered by the cast body. Specifically, those parts of the two circuit board sides are covered by the cast body that are equipped with electronic components. The electronic components are thereby fixed and protected against corrosion so that the electric solder connections between the electronic components and the conductor paths on the circuit board will not be damaged even over the long term.

In an embodiment of the present in invention, the connector core and the housing opening can, for example, be aligned axially. During the axial mounting of the secondary assembly, it is thereby possible to set the housing body axially on a second housing body which, together with the first housing body, forms the secondary assembly housing.

In an embodiment of the present invention, the cast body can, for example, be made of a thermoset molding compound. Compressive load molding compounds cure irreversibly and completely so that no gap can occur at the interface between the cast body and the connector pins even in the long term through which, for example, water vapor can enter the housing interior. Thermoset materials are also reactive so that a substance-to-substance bond between the thermoset of the cast body and the connector pins can be achieved which is and remains virtually impermeable to gas even in the long term.

In an embodiment of the present invention, the cast body can, for example, also form a connector holder laterally surrounding the connector pins, wherein the connector frame, together with the connector core, protrudes outward through the housing opening. The connector frame substantially serves to guide a corresponding part of a mating connector.

An embodiment of the present invention will be explained below under reference to the drawings.

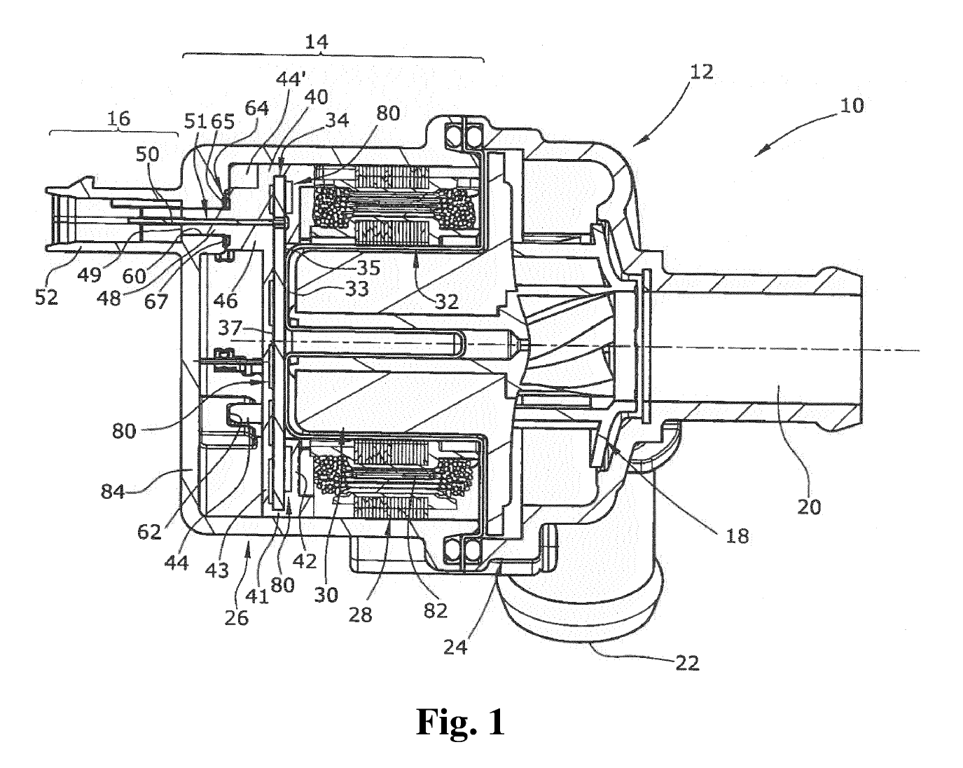

FIG. 1 is a longitudinal section of an electric motor vehicle secondary assembly 10 in the exemplary form of a water recirculation pump. The electric motor vehicle secondary assembly 10 has an electric drive motor 14 coaxially driving a working device 18 in the form of an impeller. The electric motor vehicle secondary assembly 10 has a housing 12 substantially assembled in an axial direction from a first plastic housing body 26 and a second plastic housing body 24. The second plastic housing body 24 has a coaxial and tube-like pump inlet 20 and a tangential pump outlet 22. The first plastic housing body 26 has a pot-like design and substantially accommodates the electric drive motor 14.

The electric drive motor 14 is designed as a so-called canned motor and comprises a cylindrical can 32 and a can bottom 33 lying in a transverse plane, the can 32 and the can bottom 33 together forming a so-called integral can that may be made of a plastic material or a non-magnetic metal. The can 32 separates a motor rotor 30, designed as an internal rotor and excited by permanent magnets, radially from a motor stator 28 that carries a plurality of motor coils 82 in the circumferential direction. The electric drive motor 14 further has commutation electronics 80 on a motor control circuit board 34 lying in a transverse plane, by which the motor coils 82 of the motor stator 28 can be driven or energized. A transverse plane should be understood as a plane that is almost perpendicular to the rotational axis of the motor rotor 30.

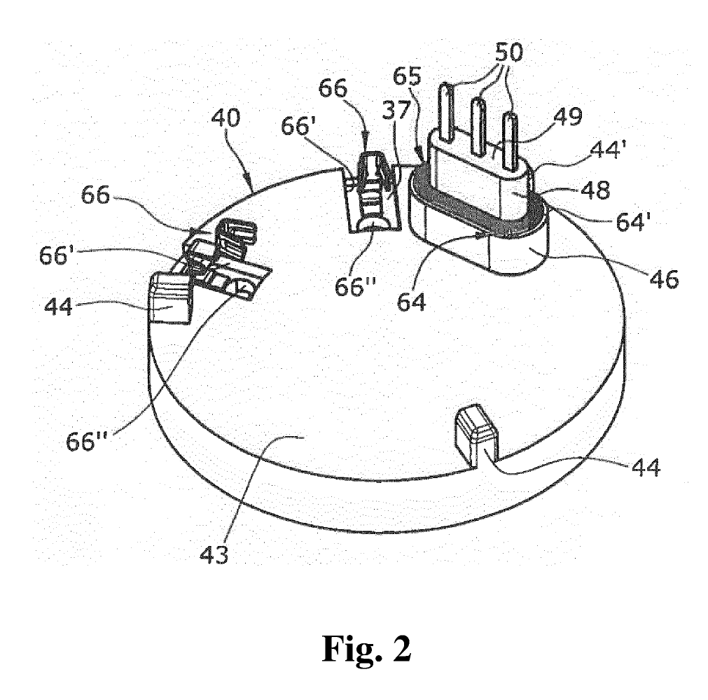

The motor control circuit board 34 including the commutation electronics 80 is embedded or potted for the greater part in a monolithic cast body 40 which is formed from a thermoset. As can in particular be seen in FIG. 2, the cast body 40 comprises a disc-shaped part 43 that covers almost all of the distal side 37 of the motor control circuit board 34, an annular part 42 that covers an annular edge strip of the proximal side 35 of the motor control circuit board 34, and a cylindrical part 41 that integrally connects the disc-shaped part 43 and the annular part 42 of the cast body 40 on the radial outer side.

On the distal side, the cast body 40 further has a connector socket 46 protruding upward in the axial direction from the disc-shaped part 43 of the cast body 40, which connector socket 46 is adjoined in the axial direction by a connector core 48. A circumferential shoulder 64 is formed between the connector socket 46 and the connector core 48, the shoulder surface 64′ thereof approximately lying in a transverse plane. The connector socket 46 and the connector core 48 enclose three pin elements 51 which protrude axially and almost vertically from the motor control circuit board 34 in the distal direction and are soldered to the motor control circuit board 34. The three pin elements 51 stand approximately in a row, i.e., they lie in a single longitudinal plane. The three pin elements 51 are longer in the axial direction than the cast body 40, the sections of the three pin elements 51 that axially protrude above the cast body 40 and are exposed, forming three connector pins 50 of a connector arrangement 16.

The first (pot-shaped) plastic housing body 26 has a substantially cylindrical circumferential wall and a disc-shaped housing body front wall 84 substantially lying in a transverse plane. The housing body front wall 84 has an axial opening 60 into which the connector core 48 is fully inserted. A circumferential sealing surface 67 is provided on the proximal side of the housing body front wall 84, which corresponds to the shoulder surface 64′. An elastic ring seal 65 is arranged between the circumferential sealing surface 67 and the shoulder surface 64′ which, in this region, provides a gas-tight sealing of the housing interior from the environment.

The distal end side of the connector core 48 forms a connector base 49 of the connector arrangement 16 that lies approximately in a transverse plane.

The connector arrangement 16 further comprises a connector frame 52 that surrounds the three connector pins 50 at a distance. In the present case, the connector frame 52 is an integral part of the housing body front wall 84, but may, as an alternative, generally also be formed by the cast body 40.

On the distal side of the cast body 40 or of its disc-shaped part 43, two recesses 66′ are provided at the edge thereof, since two motor coil clamp terminals 66 protrude from the motor control circuit board 34 in this region, into which a contact pin of the motor coils 82 is inserted through corresponding openings 66″, respectively, in the assembled state of the electric motor vehicle secondary assembly 10.

Three axial support noses 44, 44′ are further formed on the distal side of the cast body 40 at the outer edge of the disc-shaped part 43, which are supported on three axial support sockets 62 on the proximal side of the housing front wall 84 and/or which engage into the three axial support sockets 62 in a form-fitting manner. The exact axial position of the cast body 40 and the rotational position of the cast body 40 are thereby adjusted or defined relative to the housing 12.

The present invention is not limited to embodiments described herein; reference should be had to the appended claims.

What is claimed is:

1-9. (canceled)

10. An electric motor vehicle secondary assembly comprising:
a housing body comprising a housing opening;
a drive motor configured to be electronically commutated;
a working device configured to be driven by the drive motor;
a peripheral connector arrangement comprising at least two exposed connector pins;
a cast body comprising a connector core which is integrally molded thereon in one piece, the connector core being configured to form a connector base; and
a motor control circuit board which is at least partly potted in the cast body,
wherein,
the at least two exposed connector pins are each formed by a respective single rigid pin element which is directly electrically connected to the motor control circuit board,
the connector core of the cast body is configured to enclose each respective single rigid pin element between the motor control circuit board and the connector base; and
the connector core is plugged into the housing opening of the housing body so that the connector base completely closes the housing opening and the respective single pin elements project outward from the connector base through the housing opening.

11. The electric motor vehicle secondary assembly as recited in claim 10, wherein the cast body or the housing body further comprises at least two axial support nosesconfigured to axially support the cast body at the housing body.

12. The electric motor vehicle secondary assembly as recited in claim 11, wherein the cast body or the housing body further comprises at least two axial support sockets configured to axially support the at least two axial support noses which correspond to the at least two axial support sockets.

13. The electric motor vehicle secondary assembly as recited in claim 10, further comprising:
a connector socket;
a circumferential shoulder arranged between the connector core and the connector socket;
a housing-side sealing surface; and
an elastic ring seal arranged between the circumferential shoulder and the housing-side sealing surface,
wherein,
the housing-side sealing surface corresponds to the elastic ring seal, and
the connector core is arranged to sit on the connector socket.

14. The electric motor vehicle secondary assembly as recited in claim 10, wherein the motor control circuit board comprises a proximal side and a distal side, at least one of the distal side and the proximal side being at least partly covered by the cast body.

15. The electric motor vehicle secondary assembly as recited in claim 10, wherein the connector core and the housing opening are oriented in an axial direction.

16. The electric motor vehicle secondary assembly as recited in claim 10, wherein the cast body comprises a thermoset molding compound.

17. The electric motor vehicle secondary assembly as recited in claim 10, wherein the working device is an impeller.

18. The electric motor vehicle secondary assembly as recited in claim 10, further comprising:
a connector frame configured to surround the at least two exposed connector pins,
wherein,
the connector core and the connector frame are each formed by the cast body, and
the connector frame is configured to protrude outward through the housing opening.
